(19) United States
(12) Patent Application Publication
(10) Pub. No.: US 2026/0309293 A1
(43) Pub. Date: Oct. 8, 2026

(54) METHOD FOR ASSEMBLING A HEADLAMP LIGHT MODULE UNDER LIMITED ASSEMBLING SPACE CONDITIONS, HEADLAMP LIGHT MODULE, AND ASSEMBLY

(71) Applicant: Lumileds Singapore Pte. Ltd., Singapore (SG)

(72) Inventor: Matthias HOLTRUP, Aachen (DE)

(73) Assignee: Lumileds Singapore Pte. Ltd., Singapore (SG)

(21) Appl. No.: 19/483,434

(22) PCT Filed: May 13, 2024
(86) PCT No.: PCT/US2024/029105

§ 371 Date: Nov. 11, 2025

Related U.S. Application Data
(60) Provisional application No. 63/465,699, filed on May 11, 2023.

(51) Int. Cl. F21S 41/19; F21S 41/141; F21S 41/39

(52) U.S. Cl. CPC F21S 41/192; F21S 41/141; F21S 41/198; F21S 41/39; F21S 2243/00

(57) ABSTRACT

A light module assembly (10) for an automotive headlamp and a method of assembling the light module assembly (10) are disclosed. The light module assembly includes a reflector (12), a light module (14), a resilient element (16, 16′), and a fastener (18). The reflector (12) includes an upper surface (28), a rear surface (26), and a first protrusion (30) extending away from the rear surface (26 ). The light module (14) is positioned adjacent the reflector (12), such that a lower surface of the light module (14) abuts the upper surface (28) of the reflector (12). The light module includes a body (40) and an aperture (46) extending through the body (40). The resilient element (16, 16′) abuts the first protrusion (30 ) of the reflector (12) and extends through the aperture (46) of the light module (14). The resilient element (16, 16′) includes a fastener aperture (54, 54′) extending through the resilient element (16, 16′). The fastener (18) extends through the fastener aperture (54, 54′) of the resilient element and is coupled to the first protrusion (30) of the reflector (12).

### CROSS-REFERENCE TO RELATED APPLICATIONS

This application claims the benefit of U.S. Provisional Application No. 63/465,699, filed May 11, 2023, the contents of which are incorporated herein by reference.

### BACKGROUND

Automotive headlamps may include light modules that are assembled to a reflector of the automotive headlamp using a screw that is inserted into the light module and then coupled to the reflector. The screw is inserted in a top down direction with respect to the light module and the reflector. As such, such reflector and light module assemblies require accessibility above the reflector and the light module to insert the screw and then secure the light module to the reflector. In most automotive headlamps, the aforementioned space or accessibility above the reflector and the light module is limited, and therefore it is difficult to insert and secure the screw. In addition, previous automotive headlamps require positioning equipment, such as jigs or placement holders, to ensure proper and accurate positioning of the light module relative to the reflector. The positioning equipment can further limit or reduce the space above the reflector and the light module, increasing assembly difficulty.

### SUMMARY

A light module assembly for an automotive headlamp and a method of assembling the light module assembly are described. The light module assembly includes a reflector, a light module, a resilient element, and a fastener. The reflector includes an upper surface, a rear surface, and a first protrusion extending away from the rear surface. The light module is positioned adjacent the reflector, such that a lower surface of the light module abuts the upper surface of the reflector. The light module includes a body and an aperture extending through the body. The resilient element abuts the first protrusion of the reflector and extends through the aperture of the light module. The resilient element includes a fastener aperture extending through the resilient element. The fastener extends through the fastener aperture of the resilient element and is coupled to the first protrusion of the reflector.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a perspective view of a light module coupled to a reflector of an automotive headlamp;

FIG. 1B is a side view of the light module coupled to the reflector, as illustrated in FIG. 1A;

FIG. 2 is a top perspective view of a light module assembly of the present disclosure;

FIG. 3 is a side view of the light module assembly of FIG. 2;

FIG. 4 is a bottom perspective view of the light module assembly of FIG. 2;

FIG. 5 is a perspective view of a resilient element of the light module assembly;

FIG. 6 is a top perspective view of the resilient element inserted into a light module of the light module assembly;

FIG. 7 is a side cross-sectional view of the light module assembly taken along Section 7-7 of FIG. 2;

FIG. 8 is a partial side cross-sectional view of the light module assembly taken along Section 8-8 of FIG. 2;

FIG. 9A is a side view of a first step of assembling the light module assembly;

FIG. 9B is a side view of a second step of assembling the light module assembly;

FIG. 9C is a side view of a third step of assembling the light module assembly;

FIG. 9D is a side view of a fourth step of assembling the light module assembly;

FIG. 10 is a top perspective view of a second embodiment of the light module assembly of the present disclosure;

FIG. 11 is a side view of the second embodiment of the light module assembly of FIG. 10;

FIG. 12 is a bottom perspective view of the second embodiment of the light module assembly of FIG. 10;

FIG. 13 is a perspective view of a second embodiment of a resilient element of the second embodiment of the light module assembly of FIG. 10; and

FIG. 14 is a side cross-sectional view of the second embodiment of the light module assembly taken along Section 14-14 of FIG. 10.

### DETAILED DESCRIPTION

Certain terminology is used in the following description for convenience only and is not limiting. The words “front”, “rear”, “upper”, and “lower” designate directions in the drawings to which reference is made. The words “inwardly” and “outwardly” refer to directions towards and away from parts referenced in the drawings. “Axially” refers to a direction along the axis of a shaft or any other cylindrical member. A reference to a list of items that are cited as “at least one of a, b, or c” (where a, b, and c represent the items being listed) means any single one of the items a, b, or c, or combinations thereof are included. The terms “about” and “approximately” encompass +/−10% of an indicated value unless otherwise noted. The terminology includes the words specifically noted above, derivatives thereof and words of similar import.

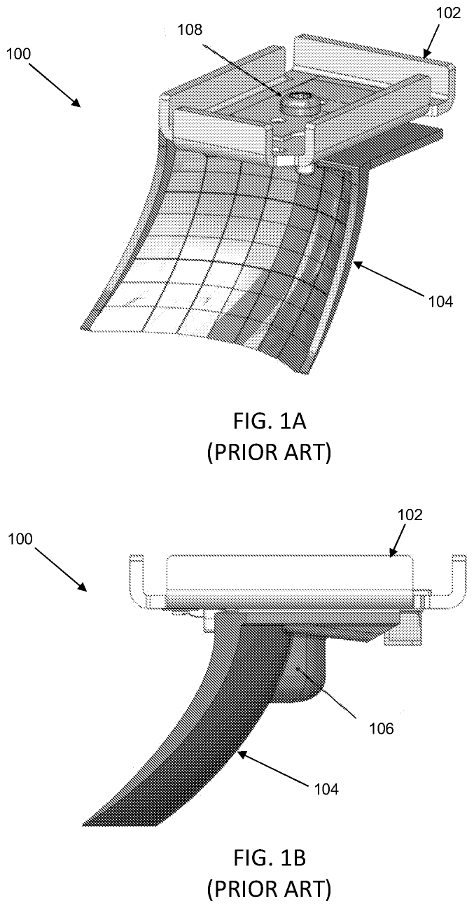

FIG. 1A is a perspective view of a light module assembly 100, which can be coupled to or within an automotive headlamp (not shown). FIG. 1B is a side view of the light module assembly 100 of FIG. 1A. The light module assembly 100 includes a light module 102, which produces light through using a light source (e.g., an LED not shown in FIGS. 1A and 1B) and a reflector 104 that is utilized to reflect or direct the produced light out through the automotive headlamp. More specifically, the light module assembly 100 includes a reflector 104 with a screw dome 106, a light module 102, and a fastener 108. To assemble the light module assembly 100, the light module 102 is placed on a surface of the reflector 104 and then positioning equipment, such as jigs or placement holders, may be used to ensure proper and accurate positioning of the light module 102 relative to the reflector 104. A screw or fastener 108 may be inserted into the light module 102 from above (relative to the views shown in FIGS. 1A and 1B), downward into the reflector 104. The screw or fastener 108 may be coupled to the screw dome 106 extending from the reflector 104, securing the light module 102 to the reflector 104.

In light model assemblies such as illustrated in FIGS. 1A and 1B, the screw or fastener 108 is inserted in a top down direction, and, therefore, requires ample open space and/or accessibility above the reflector 104 and the light module 102 to insert the screw or fastener 108. Only then, after the screw or fastener 108 has been tightened from above, can the light module 102 be coupled to the reflector 104. In most automotive headlamps, the aforementioned space or accessibility above the reflector 104 and the light module 102 is limited, and, therefore, it is difficult to insert and secure the screw or fastener 108. In addition, the positioning equipment (not shown) can further limit or reduce the space above the reflector 104 and the light module 102, increasing assembly difficulty.

As such, there is a need for a new solution that allows for an easier and more reliable assembly process. The light module assembly 10 described in detail below achieves the desired results by providing a self-aligning assembly that ensures proper positioning of the light module 14 relative to the reflector 12 without the need for extra positioning equipment and the extra assembly steps. In addition, the light module assembly 10 described herein requires minimal or no additional space above the module to assemble the light module 14 to the reflector 12. Further advantages of the light module assembly 10 described herein will be realized by those of ordinary skill in the art.

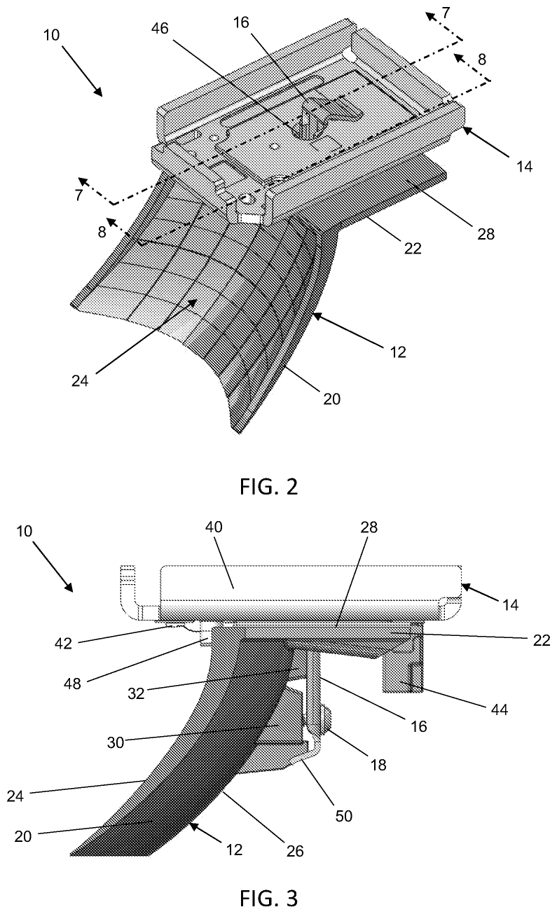

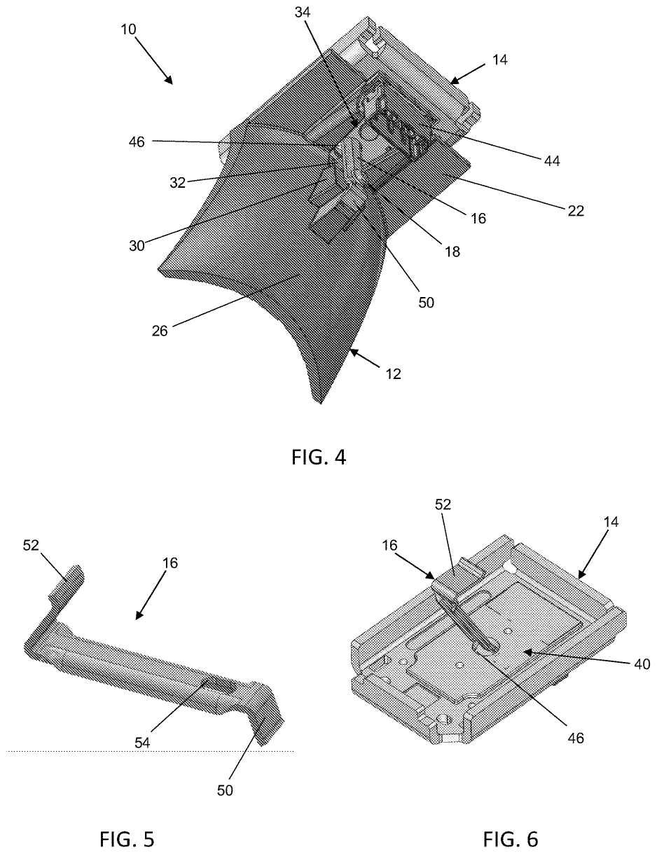

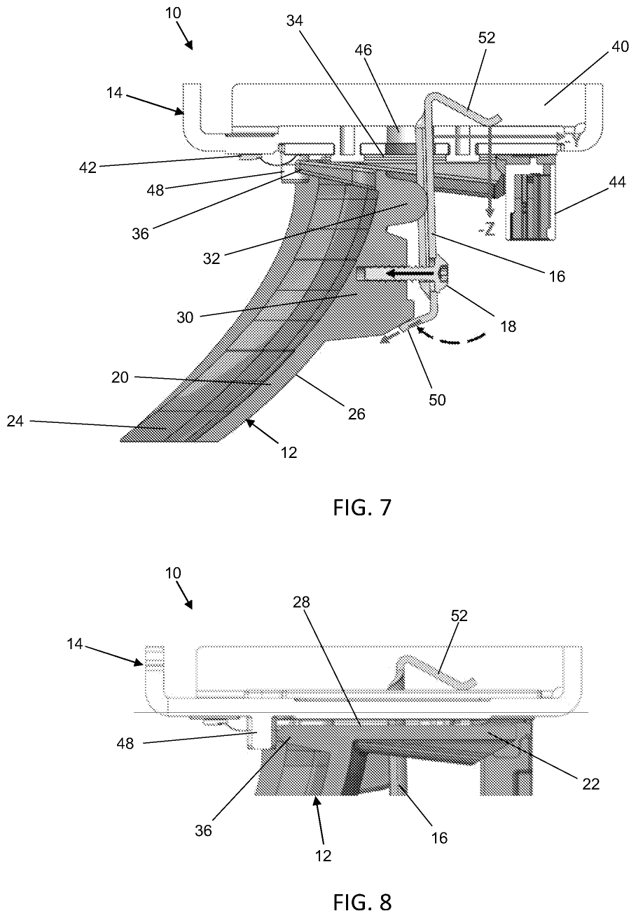

FIG. 2 is a top perspective view of an example light module assembly 10. FIG. 3 is a side view of the example light module assembly 10 of FIG. 2. FIG. 4 is a bottom perspective view of the light module assembly 10 of FIG. 2. FIG. 5 is a perspective view of a resilient element 16 of the light module assembly 10 of FIG. 2. FIG. 6 is a top perspective view of the resilient element 16 inserted into a light module 14 of the light module assembly 10. FIG. 7 is a side cross-sectional view of the light module assembly 10 taken along Section 7-7 of FIG. 2. FIG. 8 is a partial side cross-sectional view of the light module assembly 10 taken along Section 8-8 of FIG. 2.

In illustrated examples, the light module assembly 10 can include a reflector 12, a light module 14, a resilient element 16, and a fastener 18. The light module assembly 10 is configured to produce light using a light source (e.g., an LED) of the light module 14, and the reflector 12 is configured to reflect or direct the produced light out of the automotive headlamp. As such, the light module assembly 10 is configured to be installed to or within an automotive headlamp (not shown). Further, the light module assembly 10 is configured to produce and direct light in front of the automotive vehicle to provide light for the automotive vehicle during low-light conditions, as will be readily understood. The light module 14 of the light module assembly 10 is easier to install and accurately position on the reflector 12, as compared to light module assemblies such as illustrated in FIGS. 1A and 1B.

The reflector 12 may be at least partially constructed from a reflective material and configured to reflect and direct light produced by the light module 14 in a required or desired direction. The reflector 12 can have a generally arc-shaped body 20 with a horizontally extending flange 22 extending from the generally arc-shaped body 20, as illustrated best in FIGS. 2-3. Further, the reflector 12 can include a front surface 24, a rear surface 26, and an upper surface 28. The front surface 24 of the reflector 12 includes the reflective surface, which reflects or directs light emitted by the light source out of, and away from, the automotive headlamp. The rear surface 26 of the reflector 12 is opposite the reflective front surface 24 of the reflector 12, such that the rear surface 26 faces in an opposite direction from the front surface 24. In addition, the rear surface 26 is positioned on an opposite side of the generally arc-shaped body 20 than the front surface 24. The upper surface 28 of the reflector 12 may be the top or uppermost surface of the flange 22 extending horizontally from the generally arc-shaped body 20.

The reflector 12 can also include a first protrusion 30, a second protrusion 32, and a reflector aperture 34. The first protrusion 30 can extend from the rear surface 26 of the reflector 12 in a direction away from the rear surface 26 and the front surface 24. In some examples, the first protrusion 30 can extend from the rear surface 26 in the direction the flange 22 extends away from the arc-shaped body 20 of reflector 12. Likewise, the second protrusion 32 can extend from the rear surface 26 of the reflector 12 in a direction away from the rear surface 26 and the front surface 24. In some examples, the second protrusion 32 can extend from the rear surface 26 in the direction the flange 22 extends away from the arc-shaped body 20 of reflector 12. As such, the second protrusion 32 can extend from the rear surface 26 in the same direction as the first protrusion 30.

Additionally, the second protrusion 32 can be positioned vertically between the first protrusion 30 and the flange 22 of the reflector 12. More specifically, the second protrusion 32 can be positioned vertically between the first protrusion 30 and the upper surface 28 of the flange 22. In this context, the term vertically means the direction perpendicular to the extension direction of the upper surface 28 of the flange 22. In some examples, the first protrusion 30 can include a generally block or cube shape, and the second protrusion 32 can include a generally rounded shape, such as generally in the shape of a rounded knob or protrusion. Further, the second protrusion 32 can extend in a rearward direction (parallel with the upper surface 28) from the rear surface 26 of the reflector 12 a further distance from the rear surface 26 than the first protrusion 30. In other words, an end surface of the second protrusion 32 extends past an end surface of the first protrusion 30 in the rearward direction. The aforementioned orientation/positioning of the second protrusion 32 relative to the first protrusion 30 facilitates the resilient element 16 pivoting about the second protrusion 32, discussed further below.

As illustrated best in FIG. 4, the reflector aperture 34 extends fully through the flange 22 of the reflector 12, such that an opening may be present within the flange 22 of the reflector 12. In some examples, the reflector aperture 34 can be a small circular aperture extending through the flange 22. In other examples, as illustrated, the reflector aperture 34 can be a larger rectangular aperture extending through the flange 22. The reflector aperture 34 is configured to provide a location in which the resilient element 16 can extend through the flange 22 of the reflector 12. As such, the reflector aperture 34 may be sized to be large enough for the resilient element 16 to extend fully through the flange 22 of the reflector 12.

The light module 14 may be positioned directly adjacent the reflector 12, such that the light module 14 abuts the reflector 12. More specifically, the light module 14 may be positioned generally above the reflector 12, such that a lower surface of the light module 14 abuts the upper surface 28 of the reflector 12. Therefore, the light module 14 may be positioned generally aligned with the flange 22 of the reflector 12. In the illustrated examples, the light module 14 includes a body 40 that is generally rectangular in shape, such that the body 40 of the light module 14 generally corresponds to the shape of the flange 22 of the reflector 12. In other examples, the body 40 and the flange 22 can have any generally corresponding shapes.

The light module 14 can include the body 40, a light 42, a connector 44, an aperture 46, and a first guidance feature 48. The light 42 can be an LED light that is coupled to the lower surface of the light module 14 near the front end of the light module 14, such that the light 42 may be positioned closer to the front surface 24 than the rear surface 26 of the reflector 12. The light 42 may be the light source that produces the light that is directed from the automotive headlamp. The connector 44 can be an electrical connector that is coupled to the lower surface of the light module 14 near the rear end of the light module 14, such that the connector 44 may be positioned closer to the rear surface 26 than the front surface 24 of the reflector 12. In addition, the connector 44 may be positioned at an opposite end of the light module 14 and the light 42, and the connector 44 may be electrically connected to the light 42 to transfer electrical energy to the light 42. The connector 44 may be configured to be coupled to an electrical power source (e.g., a battery), such that the connector 44 can receive electrical energy and supply the electrical energy to the light 42.

The aperture 46 of the light module 14 may extend fully through the body 40 of the light module 14, allowing components to fully extend through the body 40 of the light module 14. More specifically, as illustrated in FIGS. 6 and 7, the aperture 46 may allow the resilient element 16 to fully extend through the body 40 of the light module 14. In some examples, as illustrated, the aperture 46 can be a circular aperture 46 extending through the body 40. In other examples, the aperture 46 can have any shape as long as the aperture 46 still allows the resilient element 16 to extend through the body 40 of the light module 14. In addition, as illustrated best in FIG. 6, the aperture 46 can extend through the body 40 at generally a center or central location (length and width) of the body 40.

Referring now to FIGS. 7-8, the first guidance feature 48 of the light module 14 may be coupled to the lower surface of the light module 14 near the front end of the light module 14, such that the first guidance feature 48 is positioned closer to the front surface 24 than the rear surface 26 of the reflector 12. As such, the first guidance feature 48 may be positioned adjacent the light 42 of the light module 14. Although only a single first guidance feature 48 is illustrated, it is to be understood that the light module 14 can include at least one first guidance feature 48. Some examples may include two or more first guidance features 48, with each first guidance feature 48 being positioned at the front end of the first light module 14, generally adjacent the light 42.

Further, in some examples, the first guidance feature 48 can be a pin or dowel that is configured to mate with a second guidance feature 36 of the reflector 12. Therefore, in such an example, the second guidance feature 36 can be an aperture or an indentation in the reflector 12 that is shaped and sized to mate with the first guidance feature 48 of the light module 14. In other examples, the first guidance feature 48 could be an aperture extending through the body 40 of the light module 14 and the second guidance feature 36 of the reflector 12 could include a mating guidance feature (such as a pin or dowel) that mates with the aperture guidance feature of the light module 14. In any example, the light module 14 and the reflector 12 can include mating first and second guidance features 48, 36 that aid in properly aligning the light module 14 relative to the reflector 12. Properly aligning the light module 14 relative to the reflector 12 is required to ensure the light produced by the light module 14 is reflected or directed by the reflector 12 at the desired angle and intensity.

The resilient element 16 is a component of the light module assembly 10 that is configured to aid in aligning the light module 14 relative to the reflector 12, and also to induce a force into both the light module 14 and the reflector 12 to properly secure the components together. The resilient element 16 can be constructed from an elastic material, such that the resilient element 16 may be configured resume its normal or undeformed shape once an external force is stopped from being applied to the resilient element 16. In some examples, the resilient element 16 can be constructed from a spring metal, a rubber, a polymeric material, or any other material exhibiting elastic properties.

As illustrated, the resilient element 16 can include a generally S-shaped or a reverse Z-shaped profile. Specifically, the resilient element 16 can include a first end 50 positioned at one end of the resilient element 16, and a second end 52 positioned at a second (opposite) end of the resilient element 16 as the first end 50. In the illustrated example and when installed, the first end 50 may be the end of the resilient element 16 that is positioned below the flange 22 of the reflector 12 and adjacent the first protrusion 30 of the reflector 12. The second end 52 may be the end of the resilient element 16 that is positioned above the flange 22 of the reflector 12 and contacting the body 40 of the light module 14. In other words, the first end 50 of the resilient element 16 may contact the first protrusion 30 of the reflector 12, and the second end 52 of the resilient element 16 may contact an upper surface of the body 40 of the light module 14.

The first end 50 of the resilient element 16 may include a flange or spring-like feature that may extend in a first direction and face the same direction as the front surface 24 of the reflector 12. In addition, the first end 50 of the resilient element 16 may be configured to engage with the first protrusion 30 of the reflector 12, as described in more detail below. The second end 52 of the resilient element 16 may include a flange or spring-like feature that may extend in a second direction (opposite the first direction) and face away from the front surface 24 of the reflector 12. In addition, the second end 52 of the resilient element 16 may be configured to engage with the upper or top surface of the body 40 of the light module 14 to induce both a vertical and horizontal force into the light module 14, as described in more detail below.

As shown best in FIGS. 5 and 7, the resilient element 16 may also include a fastener aperture 54 extending through the resilient element 16. The fastener aperture 54 can be positioned adjacent the first end 50 of the resilient element 16, such that the fastener aperture 54 may be positioned between the first end 50 and the second end 52 of the resilient element 16, but also closer to the first end 50 than the second end 52. The fastener aperture 54 can be a circular aperture extending through the resilient element 16, or the fastener aperture 54 can be a slot that extends through the resilient element 16, as illustrated in FIG. 5. The fastener aperture 54 may be configured to accept a fastener to aid in coupling the resilient element 16 to the reflector 12. More specifically, the light module assembly 10 may include a fastener 18 that may be configured to extend through the fastener aperture 54 of the resilient element 16 to couple and secure the resilient element 16 to the first protrusion 30 of the reflector 12. In the illustrated examples, the fastener 18 is shown as being a screw or a bolt, but it is to be understood that the fastener 18 could be any other type of fastener capable of securing the resilient element 16 to the first protrusion 30 of the reflector 12.

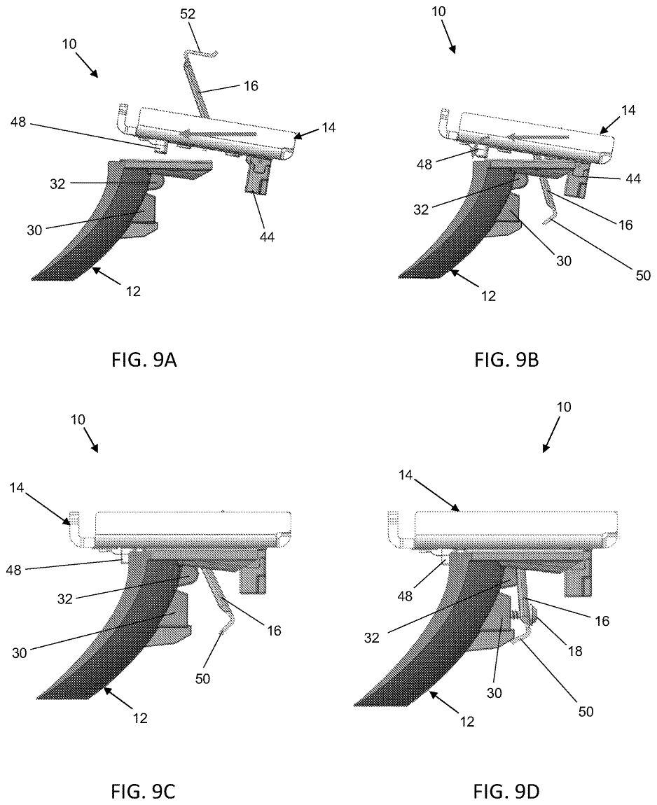

Referring now to FIGS. 9A-9D, a method of installing and coupling the light module 14 to the reflector 12 is illustrated. To begin installation, the resilient element 16 may be inserted through the aperture 46 extending through the body 40 of the light module 14. Then the light module 14 with the inserted resilient element 16 may be translated from the rear surface 26 of the reflector 12 toward the front surface 24 of the reflector 12, and the lower surface of the light module 14 may be placed on the upper surface 28 of the flange 22 of the reflector 12. The first guidance feature 48 of the light module 14 and the second guidance feature 36 of the reflector 12 may be properly aligned such that the light module 14 may be precisely placed on the reflector 12 at the correct position and angle, shown in FIGS. 9B-9C.

The first end 50 of the resilient element 16 may be rotated toward the first protrusion 30 of the reflector 12, until the first end 50 of the resilient element 16 contacts and abuts the first protrusion 30 of the reflector 12. More specifically, and as shown best in FIG. 7, the resilient element 16 may contact the second protrusion 32 at a location between the first end 50 and the second end 52 of the resilient element 16, such that the resilient element 16 may pivot about the second protrusion 32 of the reflector 12 until the first end 50 of the resilient element 16 contacts the first protrusion 30 of the reflector 12. With the first end 50 of the resilient element 16 contacting the first protrusion 30 of the reflector 12, the fastener 18 can be inserted through the fastener aperture 54 of the resilient element 16 and into an aperture within the first protrusion 30 of the reflector 12. The fastener 18 can then be screwed into or otherwise tightened to pull and/or force the first end 50 of the resilient element 16 further into contact with the first protrusion 30 of the reflector 12.

The tightening of the fastener 18 may cause the resilient element 16 to pivot about the second protrusion 32 of the reflector 12, which in turn may cause the first end 50 of the resilient element 16 to rotate toward the reflector 12 and the second end 52 of the resilient element 16 to rotate away from the reflector 12. The pivoting/rotation of the resilient element 16 about the second protrusion 32 (caused by the tightening of the fastener) may induce a force in the light module 14 that may aid in securing the light module 14 to the reflector 12. Specifically, the second end 52 of the resilient element 16 may push downward (perpendicular to the upper surface 28 of the flange 22) on the light module 14 to bias and force the light module 14 towards the upper surface 28 of the flange 22 of the reflector 12. In addition, the second end 52 of the resilient element 16 may push rearward (parallel to the upper surface 28 of the flange 22) in a direction away from the front surface and in the direction the flange 22 extends from the arc-shaped body 20 of the reflector 12.

The downward and rearward biasing forces induced by the resilient element 16 ensure that the light module 14 is accurately and precisely positioned relative to the reflector 12. Further, the downward and rearward biasing forces induced by the resilient element 16 ensures that the light module 14 remains securely coupled to the reflector 12 during use of the automotive headlamp. As such, the light module assembly 10 achieves the desired results of providing a self-aligning assembly that ensures proper positioning of the light module 14 relative to the reflector 12 without the need for extra positioning equipment and the extra assembly steps. In addition, the light module assembly 10 requires minimal or no additional space above the module to assemble the light module 14 to the reflector 12, as compared to previous approaches. Further advantages of the light module assembly 10 not specifically mentioned herein will be realized by those skilled in the art.

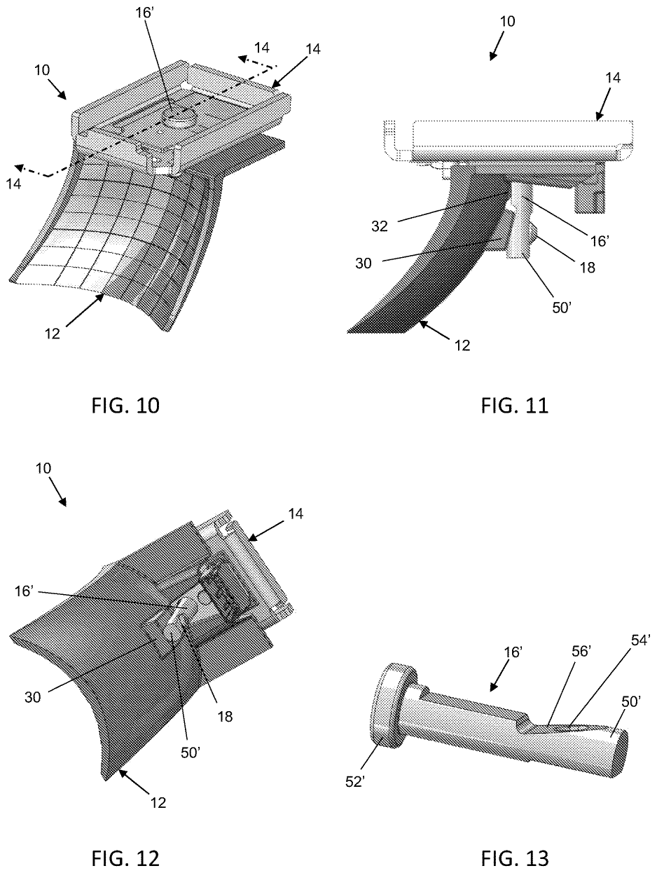

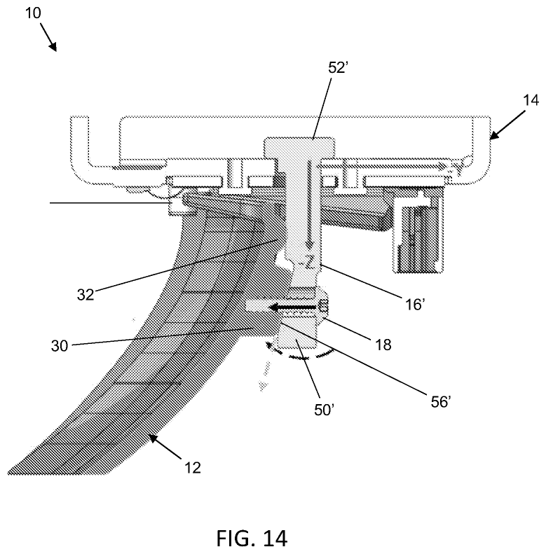

FIG. 10 is a top perspective view of a second embodiment of the light module assembly 10. FIG. 11 is a side view of the second embodiment of the light module assembly 10. FIG. 12 is a bottom perspective view of the second embodiment of the light module assembly 10. FIG. 13 is a perspective view of a second embodiment of the resilient element 16′ of the second embodiment of the light module assembly 10. FIG. 14 is a side cross-sectional view of the second embodiment of the light module assembly 10 taken along Section 14-14 of FIG. 10.

The description above regarding the first embodiment of the light module assembly 10 illustrated in FIGS. 2-9 is to be understood as equally applying to the second embodiment of the light module assembly 10 illustrated in FIGS. 10-14, except where noted. More specifically, the second embodiment of the light module assembly 10 illustrated in FIGS. 10-14 is substantially similar to the embodiment illustrated in FIGS. 2-9, except the resilient element 16′ of FIGS. 10-14 differs from the resilient element 16 of FIGS. 2-9. Therefore, only a description regarding the second embodiment of the resilient element 16′ of FIGS. 10-14 is described below.

The second embodiment of the resilient element 16′ of FIGS. 10-14 is configured to function the same as the resilient element 16 of FIGS. 2-9. More specifically, the second end 52′ of the resilient element 16′ may push downward (perpendicular to the upper surface 28 of the flange 22) on the light module 14 to bias and force the light module 14 towards the upper surface 28 of the flange 22 of the reflector 12. In addition, the second end 52′ of the resilient element 16′ pushes rearward (parallel to the upper surface 28 of the flange 22) in a direction away from the front surface and in the direction the flange 22 extends from the arc-shaped body 20 of the reflector 12. The main difference between the resilient element 16 and the resilient element 16′ may be the overall shape, which is described in more detail below.

As illustrated in FIGS. 10-14, the second embodiment of the resilient element 16′ has a generally cylindrical shape. The first end 50′ of the resilient element 16′ has a first diameter, and the second end 52′ of the resilient element 16′ has a second diameter, with the second diameter being larger or greater than the first diameter. As such, the second end 52′ of the resilient element 16′ can be considered a knob end. The second embodiment of the resilient element 16′ also includes a notch 56 having a generally triangular shape that extends into a side of the resilient element 16′ adjacent the first end 50′ of the resilient element 16′. As shown best in FIG. 14, the notch 56 is configured to abut with the first protrusion 30 of the reflector 12. Lastly, the second embodiment of the resilient element 16′ includes a fastener aperture 54′ for a fastener 18 to extend through to couple the resilient element 16′ to the reflector 12, similar to the resilient element 16 of FIGS. 2-9.

As seen from the above, the second embodiment of the resilient element 16′ of FIGS. 10-14 has a different shape than the resilient element 16 of FIGS. 2-9, but the overall functionality of the resilient element 16′ is the same as the resilient element 16. Therefore, to avoid redundancy, the installation and forces induced by the resilient element 16′ will not be described again. Rather, it is to be understood that the description regarding the resilient element of FIGS. 2-9 equally applies to the resilient element of FIGS. 10-14, except for the overall shape of the different resilient elements. Further, the advantages of the resilient element 16 equally apply to the resilient element 16′, as will be understood by those skilled in the art.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

1. A light module assembly for an automotive headlamp, the light module assembly comprising:
a reflector including an upper surface, a rear surface, and a first protrusion extending away from the rear surface;
a light module positioned adjacent the reflector, such that a lower surface of the light module abuts the upper surface of the reflector, the light module comprising a body and an aperture extending through the body;
a resilient element abutting the first protrusion of the reflector and extending through the aperture of the light module, the resilient element including a fastener aperture extending through the resilient element; and
a fastener extending through the fastener aperture of the resilient element and into the first protrusion of the reflector.

2. The light module assembly of claim 1, wherein the reflector further includes a second protrusion extending away from the rear surface, wherein the second protrusion is positioned between the first protrusion and the upper surface of the reflector and abuts the resilient element.

3. The light module assembly of claim 2, wherein the second protrusion has a rounded shape.

4. The light module assembly of claim 3, wherein the resilient element further includes a first end positioned at one end of the resilient element and a second end positioned at an opposite end of the resilient element as the first end.

5. The light module assembly of claim 4, wherein the resilient element abutspivots the second protrusion at a location between the first and second ends of the resilient element.

6. The light module assembly of claim 4, wherein the first end of the resilient element contacts the first protrusion of the reflector and the second end of the resilient element contacts an upper surface of the light module.

7. The light module assembly of claim 6, wherein the resilient element induces a force in the light module that causes the light module to bias:
downward towards the upper surface of the reflector in a direction perpendicular to the upper surface of the reflector; and
away from the rear surface of the reflector in a direction parallel with the upper surface of the reflector.

8. The light module assembly of claim 1, wherein the light module includes a first guidance feature and the reflector includes a second guidance feature configured to mate with the first guidance feature, the first and second guidance features being configured to aid in alignment of the light module relative to the reflector.

9. The light module assembly of claim 8, wherein the first guidance feature is a pin or dowel and the second guidance feature is an aperture or an indentation.

10. The light module assembly of claim 1, wherein the light module further includes a connector extending from the lower surface of the light module, the connector being configured to supply electrical power to the light module.

11. The light module assembly of claim 1, wherein the resilient element includes generally an S-shaped or a reverse Z-shaped profile.

12. The light module assembly of claim 11, wherein a first end of the resilient element extends in a first direction and a second end of the resilient element extends in a second direction, with the first direction and the second direction being opposite directions.

13. The light module assembly of claim 11, wherein the resilient element is constructed from an elastic material.

14. The light module assembly of claim 1, wherein the resilient element has a generally cylindrical shape.

15. The light module assembly of claim 14, wherein a first end of the resilient element has a first diameter and a second end of the resilient element has a second diameter, with the second diameter being greater than the first diameter.

16. The light module assembly of claim 14, wherein a notch having a generally triangular shape extends into a side of the resilient element adjacent the first end of the resilient element.

17. A method of assembling a light module on a reflector of an automotive headlamp, the method comprising:
placing the light module on an upper surface of the reflector;
inserting a resilient element through an aperture extending through the light module;
abutting the resilient element against the reflector; and
coupling a fastener to the reflector, such that the fastener extends through a fastener aperture within the resilient element and into the reflector and forces the resilient element into contact with the reflector.

18. The method of claim 17 further comprising pivoting, before coupling the fastener to the reflector, the resilient element about a second protrusion extending from a rear surface of the reflector.

19. The method of claim 18 further comprising abutting, after pivoting the resilient element about the second protrusion, a first end of the resilient element against a first protrusion extending from a rear surface of the reflector, such that the fastener is coupled to the first protrusion of the reflector.

20. The method of claim 18, wherein pivoting the resilient element about the second protrusion induces:
a first force in the light module that causes the light module to translate away from the rear surface of the reflector in a direction parallel with the upper surface of the reflector, and
a second force in the light module that causes the light module to push downward on the upper surface of the reflector in a direction perpendicular to the upper surface of the reflector.
